(19) United States
(12) Patent Application Publication
(10) Pub. No.: US 2024/0272399 A1
(43) Pub. Date: Aug. 15, 2024

(54) LENS ASSEMBLY

(71) Applicant: SAMSUNG ELECTRO-MECHANICS CO., LTD., Suwon-si (KR)

(72) Inventors: Seong Jin CHOI, Suwon-si (KR); Young Suk KANG, Suwon-si (KR)

(73) Assignee: SAMSUNG ELECTRO-MECHANICS CO., LTD., Suwon-si (KR)

(21) Appl. No.: 18/522,775

(22) Filed: Nov. 29, 2023

(30) Foreign Application Priority Data
Feb. 9, 2023 (KR) 10-2023-0017625

(51) Int. Cl. G02B 7/02; G02B 1/08; G02B 1/11

(52) U.S. Cl. CPC G02B 7/023; G02B 1/08; G02B 1/11

(57) ABSTRACT

A lens assembly is provided. The lens assembly includes a lens including an optical portion that refracts light and a flange portion that extends from the optical portion; an optical film contacting at contacts a first surface of the lens; and a lens barrel configured to accommodate the lens and the optical film, wherein the optical film may include a straight portion that is formed on a portion of a circumference of the optical film, and the lens may include a linear portion that is formed on the first surface of the lens, and is configured to contact the straight portion of the optical film.

### CROSS-REFERENCE TO RELATED APPLICATIONS

This application claims the benefit under 35 USC § 119(a) of Korean Patent Application No. 10-2023-0017625 filed on Feb. 9, 2023, in the Korean Intellectual Property Office, the entire disclosure of which is incorporated herein by reference for all purposes.

### BACKGROUND

### 1. Field

The following description relates to a lens assembly.

### 2. Description of the Background

Typically, a lens assembly may be installed in a portable communication terminal such as, as only examples, a mobile phone, a personal digital assistant (PDA), a portable personal computer (PC), a virtual reality (VR) device, and the like.

It may be an objective to maintain optical performance of the associated device while reducing the thickness of lens assemblies disposed in VR devices. A polarizing film may be disposed on the lens assembly to maintain optical performance. If the polarizing film rotates about an optical axis, the optical performance of the lens assembly may vary significantly, which may be a problem.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens assembly includes a lens including an optical portion that refracts light and a flange portion that extends from the optical portion; an optical film that contacts a first surface of the lens; and a lens barrel configured to accommodate the lens and the optical film, wherein the optical film includes a straight portion that is formed on a portion of a circumference of the optical film, and wherein the lens includes a linear portion that is formed on the first surface of the lens, and is configured to contact the straight portion of the optical film.

The linear portion of the lens may be formed inside an edge of the flange portion of the lens.

The circumference of the optical film may include the straight portion and an arc surface connected to a first end of the straight portion and a second end of the straight portion.

The optical film may include a polarizing film and a wave plate that are stacked in an optical axis direction.

Each of the polarizing film and the wave plate may include the straight portion.

The optical film may further include an anti-reflection film that is stacked on the polarizing film, and the anti-reflection film may include the straight portion.

A coating layer may be formed on at least one of the first surface of the lens and a second surface of the lens.

The lens may further include a decut portion that is formed on an edge of the flange portion of the lens.

In a general aspect, a lens assembly includes a lens including an optical portion that refracts light and a flange portion that extends from the optical portion; an optical film that contacts a first surface of the lens; and a lens barrel configured to accommodate the lens and the optical film, wherein the optical film includes a first straight portion that extends in a first direction from an arbitrary first outer point of the optical film, and a second straight portion that extends in a second direction from the arbitrary first outer point of the optical film, and wherein the lens includes a first linear portion that contacts the first straight portion and a second linear portion that contacts the second straight portion.

Each of the first linear portion of the lens and the second linear portion of the lens may be formed inside an edge of the flange portion of the lens.

The first straight portion of the optical film and the second straight portion of the optical film may form an obtuse angle with each other.

A distance from the first outer point of the optical film to an optical axis in a direction perpendicular to the optical axis may be less than a radius of the optical film.

The optical film may include a polarizing film and a wave plate that are stacked in an optical axis direction.

Each of the polarizing film and the wave plate may include the first straight portion and the second straight portion.

A coating layer may be formed on at least one of the first surface of the lens and a second surface of the lens.

The lens may further include a decut portion that is formed on an edge of the flange portion of the lens.

In a general aspect, a lens assembly includes a lens comprising an optical portion and a flange portion; and an optical film that contacts a first surface of the lens; wherein the lens comprises a first linear portion and a second linear portion, wherein the optical film comprises an anti-reflection film, a polarizing film, and a wave plate, wherein each of the anti-reflection film, the polarizing film, and the wave plate of the optical film comprises a first straight portion and a second straight portion, and wherein the first linear portion of the lens is aligned with the first straight portion of the optical film, and the second linear portion of the lens is aligned with the second straight portion of the optical film.

A first end of the first straight portion may be connected to a first end of the second straight portion at a common point, and wherein a second end of the first straight portion and a second end of the second straight portion may be connected to each other through an arc surface of the optical film.

The optical film may be fixed to the first surface of the lens.

Other features and examples will be apparent from the following detailed description, the drawings, and the claims.

### BRIEF DESCRIPTION OF DRAWINGS

FIG. 1 illustrates a perspective view of an example lens assembly, in accordance with one or more embodiments.

FIG. 2 illustrates an exploded perspective view of an example lens assembly, in accordance with one or more embodiments.

FIG. 3A and FIG. 3B are perspective views illustrating an example lens and an example optical film, in accordance with one or more embodiments.

FIG. 4 illustrates a perspective view of an example optical film, in accordance with one or more embodiments.

FIG. 5A and FIG. 5B are perspective views of an example lens and an example optical film, in accordance with one or more embodiments.

FIG. 6 illustrates a perspective view of an example optical film, in accordance with one or more embodiments.

FIG. 7A and FIG. 7B are perspective views illustrating an example lens and an example optical film, in accordance with one or more embodiments.

FIG. 8 illustrates a perspective view of an example optical film, in accordance with one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning, e.g., the phrasing “in one example” has a same meaning as “in one embodiment”, and “one or more examples” has a same meaning as “in one or more embodiments.”

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

One or more example may provide a lens assembly in which an optical film may not rotate while in contact with a lens.

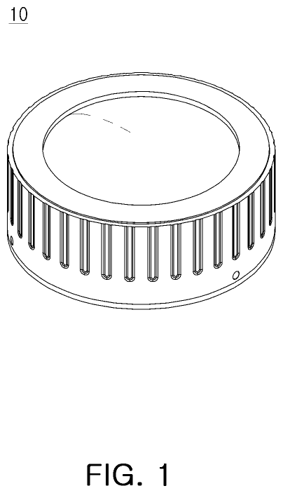

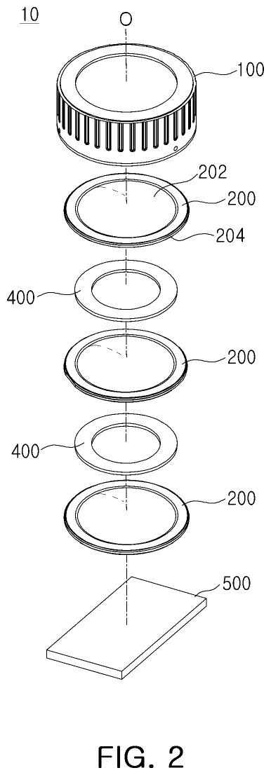

FIG. 1 illustrates a perspective view of an example lens assembly. FIG. 2 illustrates an exploded perspective view of the example lens assembly and display of FIG. 1.

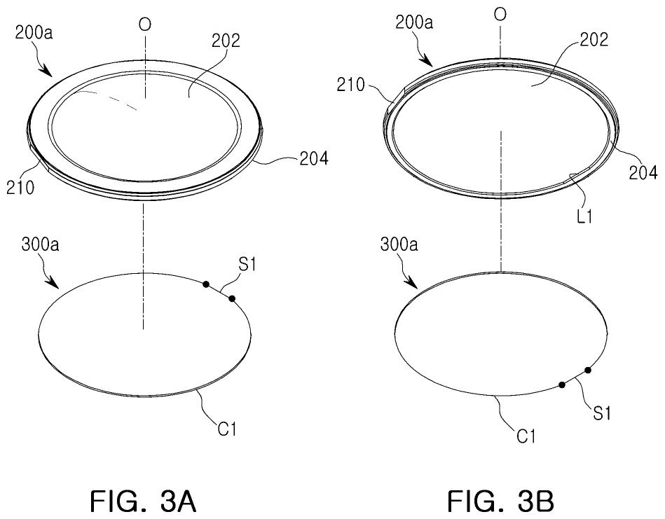

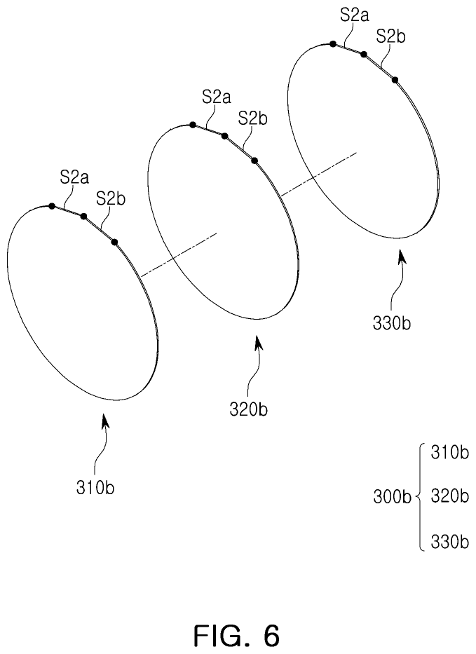

Referring to FIG. 1, FIG. 2, FIG. 3A, FIG. 3B, FIG, 4, FIG, 5A, FIG, 5B, FIG. 6, FIG, 7A, FIG, 7B, and FIG, 8, a lens assembly 10, in accordance with one or more embodiments, may include one or more lenses 200, optical films 300a, 300b, and 300c, and a lens barrel 100 disposed along an optical axis.

One or more lenses 200 may be provided, and the one or more lenses 200 may be sequentially placed on the lens barrel 100 along an optical axis.

Referring to FIG. 2, in a non-limited example, three lenses 200 stacked along the optical axis are illustrated. However, this is only an example, and the one or more examples are not limited to the number of lenses 200. In an example, depending on a resolution to be implemented, fewer or more lenses 200 may be further included. The lenses 200 may be stacked as many times as necessary depending on the implementation of the lens assembly 10, and each of the lenses may have optical properties such as the same or a different refractive index.

The lenses 200 may be formed of glass, glass molding, a thermosetting resin, a thermoplastic resin, plastic, or the like, as only examples. However, the one or more examples are not limited thereto.

The lenses 200 may include an optical portion 202 through which light is refracted as light passes and a flange portion 204 that extends from the optical portion 202.

The optical portion 202 may refract light reflected from a subject. Accordingly, the optical portion 202 may have a concave, convex or meniscus shape.

The flange portion 204 may be formed to extend from the optical portion 202, and may be formed at an edge of the optical portion 202. In an example, the flange portion 204 may be a portion that contacts a lens barrel 100 or a spacer 400. In one or more examples, at least one of the lens 200 may include a decut portion 210 that is formed on the flange portion 204.

In the one or more examples, optical films 300a, 300b, and 300c may contact at least one of the lenses 200. In the one or more examples, for convenience of explanation, the lenses 200, with which the respective optical films 300a, 300b, and 300c are in contact, is referred to as a first lens 200a and described. The first lens 200a may be one of the lenses 200 illustrated in FIG. 2. Although not illustrated in FIG. 2, the optical films 300a, 300b, and 300c may contact one surface of the first lens 200a and may be fixed to the first lens 200a through an adhesive.

In an example, at least one of the lenses 200 may include a coating layer. The coating layer may be formed on at least one of a first surface and a second surface of the lens 200. In an example, a coating layer may be formed on a surface of one of the lenses 200 through which light enters or exits. The coating layer may allow only a portion of light to be transmitted.

A spacer 400 may be disposed between the plurality of lenses 200 to maintain an interval between the lenses 200.

One or more spacers 400 may be provided depending on the number of lenses 200. The spacer 400 may be disposed between two adjacent lenses 200, so that the lenses 200 are disposed to be spaced apart by a predetermined interval. A thickness of the spacer 400 may be determined according to the interval between the lenses 200.

A light blocking material may be coated or a light blocking film may be attached to the spacer 400 to prevent unnecessary light from passing through the spacer 400.

The lens barrel 100 may have a hollow cylindrical shape so that at least one lens 200, an optical film, and a spacer 400 may be accommodated therein. In an example, press fitting or bonding using an adhesive may be used to fix at least one lens 200 to the lens barrel 100.

The lens assembly 10 may be connected to a display 500. The display 500 may include a panel, a projector, and a control circuit to control the same.

The display 500 may display an image, and light may be incident on the lens assembly 10 disposed adjacent to the display 500. The light incident on the lens assembly 10 may pass through the lens 200, and an image may be formed above the lens assembly 10.

Typically, the optical film was fixed using an adhesive to be adhered to the lens. However, when the adhesive was deformed, the optical film would rotate around an optical axis, which could significantly change the resolution of the lens assembly.

However, according to the one or more examples, the optical films 300a, 300b, and 300c and the lenses 200 may include a structure that prevents rotation, so that the lens assembly 10 can maintain a constant resolution.

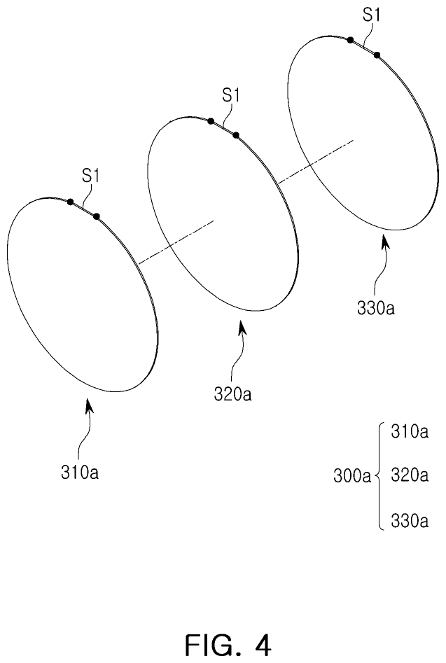

FIG. 3A and FIG. 3B are perspective views illustrating an example lens and an example optical film, in accordance with one or more embodiments. FIG. 4 is a perspective view illustrating an example optical film, in accordance with one or more embodiments.

FIG. 3A illustrates an upper perspective view of a first lens 200a and an optical film 300a, and FIG. 3B is a bottom perspective view of a first lens 200a and an optical film 300a. Referring to FIG. 3A and FIG. 3B, the optical film 300a may include a straight portion S1 formed on a portion of a circumference of the optical film 300a. Additionally, the circumference of the optical film may further include a straight portion S1 and an arc surface C1 connected to both ends of the straight portion S1.

The first lens 200a, that contacts the optical film 300a, may include a linear portion L1 disposed to face the straight portion S1 of the optical film 300a. In an example, the linear portion L1 of the first lens 200a may be formed inside an edge of the first lens 200a, and the linear portion L1 may be formed on one surface of the first lens 200a that contacts the optical film 300a.

In accordance with one or more embodiments, the optical film 300a may be disposed to contact one surface of the first lens 200a, and the optical film 300a may be adhered to the first lens 200a using, as only examples, an adhesive, or the like. When the optical film 300a contacts the first lens 200a, the straight portion S1 of the optical film 300a and the linear portion L1 of the first lens 200a may be disposed to contact each other. Accordingly, a state in which the straight portion S1 of the optical film 300a contacts the linear portion L1 of the first lens 200a may be maintained, and even if a remainder of the circumference of the optical film 300a is circular, it may not rotate in a direction of an optical axis.

The first lens 200a may include a decut (or D-cut) portion 210 formed on a flange portion 204 of the first lens 200a. In an example, the decut portion 210 may be formed on an edge of the flange portion 204, and the decut portion 210 may be cut into a “D” shape.

The optical film 300a, in accordance with one or more embodiments, may modify light incident on the first lens 200a.

Referring to FIG. 4, in an example, the optical film 300a may include a polarizing film 320a and a wave plate 330a, and may control light incident on the optical film 300a. In an example, the polarizing film 320a may convert the transmitted light into linear polarization, and the wave plate 330a may include a quarter wave plate (QWP) that converts a direction of a polarization axis.

The optical film 300a may further include an anti-reflection film 310a. In an example, the anti-reflection film 310a may be stacked on an upper surface of the optical film 300a to protect the optical film 300a. The anti-reflection film 310a may lower reflectance of light incident on the optical film 300a.

Referring again to FIG. 4, the optical film 300a may be implemented in a manner in which an anti-reflection film 310a, a polarizing film 320a, and a wave plate 330a are sequentially stacked. In accordance with one or more embodiments, the anti-reflection film 310a, the polarizing film 320a, and the wave plate 330a may respectively include a straight portion S1. In the anti-reflection film 310a, the straight portion S1 may be formed on a portion of a circumference of the anti-reflection film 310a. Likewise, in the polarizing film 320a, the straight portion S1 may be formed on a portion of a circumference of the polarizing film 320a, and in the wave plate 330a, the straight portion S1 may be formed on a portion of a circumference of the wave plate 330a. The straight portion S1 of the polarizing film 320a, the straight portion S1 of the anti-reflection film 310a, and the straight portion S1 of the wave plate 330a may be disposed to face each other.

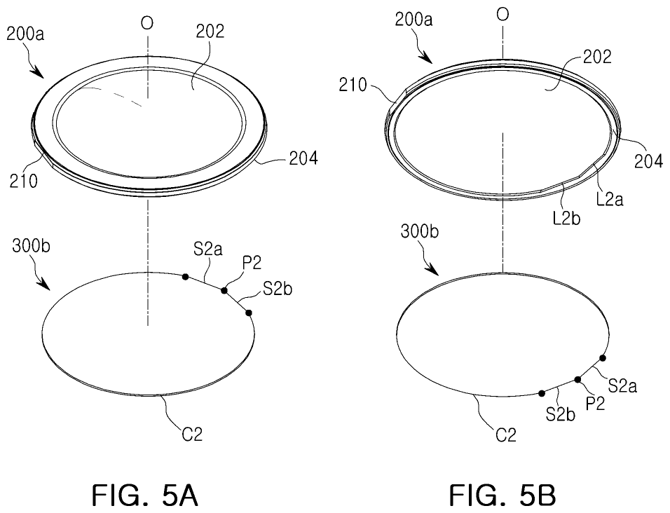

FIG. 5A and FIG. 5B are perspective views illustrating an example lens and an example optical film, in accordance with one or more embodiments. FIG. 6 is a perspective view illustrating an example optical film, in accordance with one or more embodiments.

FIG. 5A illustrates an upper perspective view of a first lens 200a and an optical film 300b, and FIG. 5B is a bottom perspective view of a first lens 200a and an optical film 300b. Referring to FIG. 5A and FIG. 5B, the optical film 300b may include a first straight portion S2a that extends in a first direction from an arbitrary outer point (or a common point) P2 of the optical film 300b and a second straight portion S2b that extends in a second direction. In an example, the first straight portion S2a and the second straight portion S2b may contact each other at the first outer point P2, and the optical film 300b may include a “V” shaped inclined surface. An end portion of the first straight portion S2a and an end portion of the second straight portion S2b may be connected to each other through an arc surface C2 formed on a remaining circumference of the optical film 300b. In an example, the first outer point P2 may be formed at a position spaced apart from an optical axis by a radius of the arc surface C2, and the first straight portion S2a and the second straight portion S2b may form an obtuse angle.

The first lens 200a may include a first linear portion L2a that contacts the first straight portion, and a second linear portion L2b that contacts the second straight portion S2b. The first linear portion L2a and the second linear portion L2b may be formed on a flange portion 204 of the first lens 200a. For example, the first linear portion L2a and the second linear portion L2b may be formed to extend in a first direction and a second direction, respectively, from an arbitrary inner point inside an edge of the flange portion 204. Accordingly, the first linear portion L2a and the second linear portion L2b may be formed inside the edge of the flange portion 204.

In accordance with one or more embodiments, the first linear portion L2a of the first lens 200a may contact the first straight portion S2a of the optical film 300b, and the second linear portion L2b of the first lens 200a may contact the second straight portion S2b of the optical film 300b, to prevent an optical film 300b from rotating while in contact with the first lens 200a.

The first lens 200a may include a decut portion 210 formed on the flange portion 204. In an example, the decut portion 210 may be formed on the edge of the flange portion 204, and the decut portion 210 may be cut into a “D” shape.

Likewise, the optical film 300b, in accordance with one or more embodiments, may modify light incident on the first lens 200a.

Referring to FIG. 6, in an example, the optical film 300b may include a polarizing film 320b and a wave plate 330b, and may control light incident on the optical film 300b. As an example, the polarizing film 320b may convert the transmitted light into linear polarization, and the wave plate 330b may include a quarter wave plate (QWP) to convert the polarization axis direction. The optical film 300b may further include an anti-reflection film 310b.

Referring again to FIG. 6, the optical film 300b may be implemented in a manner in which an anti-reflection film 310b, a polarizing film 320b, and a wave plate 330b are sequentially stacked. In accordance with one or more embodiments, the anti-reflection film 310b, the polarizing film 320b, and the wave plate 330b may each include a first straight portion S2a and a second straight portion S2b, respectively.

In the anti-reflection film 310b, the first straight portion S2a and the second straight portion S2b may be formed to extend in a first direction and a second direction, respectively, from an arbitrary outer point of the anti-reflection film 310b. Likewise, in the polarizing film 320b, the first straight portion S2a and the second straight portion S2b may be formed to extend in a first direction and a second direction, respectively, from an arbitrary outer point of the polarizing film 320b.

In the wave plate 330b, the first straight portion S2a and the second straight portion S2b may be formed by extending in a first direction and a second direction, respectively, from an arbitrary outer point of the wave plate 330b. The first straight portion S2a of the polarizing film 320b, the first straight portion S2a of the anti-reflection film 310b, and the first straight portion S2a of the wave plate 330b may be disposed to face each other. Additionally, the second straight portion S2b of the polarizing film 320b, the second straight portion S2b of the anti-reflection film 310b, and the second straight portion S2b of the wave plate 330b may be disposed to face each other.

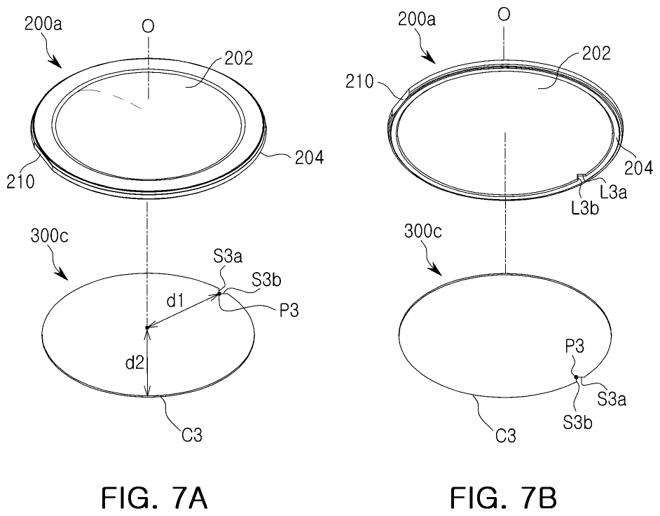

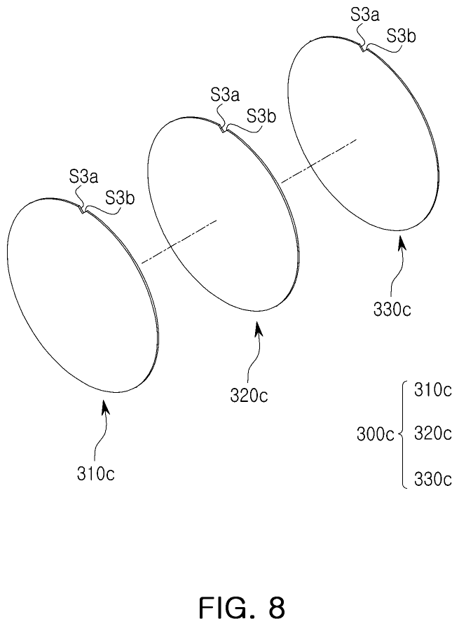

FIG. 7A and FIG. 7B are perspective views illustrating an example first lens and an example optical film, in accordance with one or more embodiments. FIG. 8 is a perspective view illustrating an example optical film, in accordance with one or more embodiments.

FIG. 7A illustrates a top perspective view of an example first lens 200a and an example optical film 300c, and FIG. 7B is a bottom perspective view of an example first lens 200a and an example optical film 300c.

Referring to FIG. 7A and FIG. 7B, the example optical film 300c may include a first straight portion S3a that extends in a first direction from an arbitrary first outer point P3 of the optical film 300c and a second straight portion S3b that extends in the second direction. In an example, the first straight portion S3a and the second straight portion S3b may contact each other at the first outer point P3, and the optical film 300c may include a “V” shaped inclined surface. An end of the first straight portion S3a and an end of the second straight portion S3b may be connected to each other through an arc surface C3 formed on a remaining circumference of the optical film 300c.

In accordance with one or more embodiments, a distance d1 from the first outer point P3 to the optical axis in a direction perpendicular to the optical axis may be less than a radius d2 of the optical film. That is, the first outer point P3 may be disposed inside the arc surface C3 formed on a portion of the circumference of the optical film 300c. In an example, the optical film 300c may be a circular film with a “V” shaped groove.

The first lens 200a may include a first linear portion L3a that contacts the first straight portion S3a, and a second linear portion L3b that contacts the second straight portion S3b. The first linear portion L3a and the second linear portion L3b may be formed on a flange portion 204 of the first lens 200a. In an example, the first linear portion L3a and the second linear portion L3b may be formed to extend in one direction and the other direction, respectively, from an arbitrary inner point inside an edge of the flange portion 204. Accordingly, the first linear portion L3a and the second linear portion L3b may be formed inside the edge of the flange portion 204.

In accordance with one or more embodiments, the first linear portion L3a of the first lens 200a may contact the first straight portion S3a of the optical film 300c, and the second linear portion L3b of the first lens 200a may contact the second straight portion S3b of the optical film 300c, so that it is possible to prevent the optical film 300c from rotating while in contact with the first lens 200a.

The first lens 200a may include a decut portion 210 formed on the flange portion 204. In an example, the decut portion 210 may be formed on an edge of the flange portion 204, and the decut portion 210 may be cut into a “D” shape.

Likewise, the optical film 300c, in accordance with one or more embodiments, may modify light incident on the first lens 200a.

In an example, referring to FIG. 8, the optical film 300c may include a polarizing film 320c and a wave plate 330c, and may control light incident on the optical film 300c. In an example, the polarizing film 320c may convert the transmitted light into linear polarization, and the wave plate 330c may include a quarter wave plate (QWP) that converts a direction of a polarization axis. The optical film 300c may further include an anti-reflection film 310c.

Referring again to FIG. 8, the optical film 300c may comprise an anti-reflection film 310c, a polarizing film 320c, and a wave plate 330c, that are sequentially stacked. In accordance with one or more embodiments, the anti-reflection film 310c, the polarizing film 320c, and the wave plate 330c may include a first straight portion S3a and a second straight portion S3b, respectively.

In the anti-reflection film 310c, the first straight portion S3a and the second straight portion S3b may be formed to extend in a first direction and a second direction, respectively, from an arbitrary outer point of the anti-reflection film 310c. Likewise, in the polarizing film 320c, the first straight portion S3a and the second straight portion S3b may be formed to extend in a first direction and a second direction, respectively, from an arbitrary outer point of the polarizing film 320c. In the wave plate 330c, the first straight portion S3a and the second straight portion S3b may be formed to extend in a first direction and a second direction, respectively, from an arbitrary outer point of the wave plate 330c. In an example, each of the anti-reflection film 310c, the polarizing film 320c, and the wave plate 330c may be a circular film with a “V” shaped groove. The first straight portion S3a of the polarizing film 320c, the first straight portion S3a of the anti-reflection film 310c, and the first straight portion S3a of the wave plate 330c may be disposed to face each other. Additionally, the second straight portion S3b of the polarizing film 320c, the second straight portion S3b of the anti-reflection film 310c, and the second straight portion S3b of the wave plate 330c may be disposed to face each other.

As set forth above, in accordance with one or more embodiments having such a configuration, the optical film may not rotate while in contact with the lens.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A lens assembly, comprising:
a lens comprising an optical portion that refracts light and a flange portion that extends from the optical portion;
an optical film that contacts a first surface of the lens; and
a lens barrel configured to accommodate the lens and the optical film,
wherein the optical film comprises a straight portion that is formed on a portion of a circumference of the optical film, and
wherein the lens comprises a linear portion that is formed on the first surface of the lens, and is configured to contact the straight portion of the optical film.

2. The lens assembly of claim 1, wherein the linear portion of the lens is formed inside an edge of the flange portion of the lens.

3. The lens assembly of claim 1, wherein the circumference of the optical film comprises the straight portion and an arc surface connected to a first end of the straight portion and a second end of the straight portion.

4. The lens assembly of claim 1, wherein the optical film comprises a polarizing film and a wave plate that are stacked in an optical axis direction.

5. The lens assembly of claim 4, wherein each of the polarizing film and the wave plate comprises the straight portion.

6. The lens assembly of claim 4, wherein the optical film further comprises an anti-reflection film that is stacked on the polarizing film, and
the anti-reflection film includes the straight portion.

7. The lens assembly of claim 1, wherein a coating layer is formed on at least one of the first surface of the lens and a second surface of the lens.

8. The lens assembly of claim 1, wherein the lens further comprises a decut portion that is formed on an edge of the flange portion of the lens.

9. A lens assembly, comprising:
a lens comprising an optical portion that refracts light and a flange portion that extends from the optical portion;
an optical film that contacts a first surface of the lens; and
a lens barrel configured to accommodate the lens and the optical film,
wherein the optical film comprises a first straight portion that extends in a first direction from an arbitrary first outer point of the optical film, and a second straight portion that extends in a second direction from the arbitrary first outer point of the optical film, and
wherein the lens comprises a first linear portion that contacts the first straight portion and a second linear portion that contacts the second straight portion.

10. The lens assembly of claim 9, wherein each of the first linear portion of the lens and the second linear portion of the lens is formed inside an edge of the flange portion of the lens.

11. The lens assembly of claim 9, wherein the first straight portion of the optical film and the second straight portion of the optical film form an obtuse angle with each other.

12. The lens assembly of claim 9, wherein a distance from the first outer point of the optical film to an optical axis in a direction perpendicular to the optical axis is less than a radius of the optical film.

13. The lens assembly of claim 9, wherein the optical film comprises a polarizing film and a wave plate that are stacked in an optical axis direction.

14. The lens assembly of claim 13, wherein each of the polarizing film and the wave plate comprises the first straight portion and the second straight portion.

15. The lens assembly of claim 9, wherein a coating layer is formed on at least one of the first surface of the lens and a second surface of the lens.

16. The lens assembly of claim 9, wherein the lens further comprises a decut portion that is formed on an edge of the flange portion of the lens.

17. A lens assembly, comprising:
a lens comprising an optical portion and a flange portion; and
an optical film that contacts a first surface of the lens;
wherein the lens comprises a first linear portion and a second linear portion,
wherein the optical film comprises an anti-reflection film, a polarizing film, and a wave plate,
wherein each of the anti-reflection film, the polarizing film, and the wave plate of the optical film comprises a first straight portion and a second straight portion, and
wherein the first linear portion of the lens is aligned with the first straight portion of the optical film, and the second linear portion of the lens is aligned with the second straight portion of the optical film.

18. The lens assembly of claim 17, wherein a first end of the first straight portion is connected to a first end of the second straight portion at a common point, and
wherein a second end of the first straight portion and a second end of the second straight portion are connected to each other through an arc surface of the optical film.

19. The lens assembly of claim 17, wherein the optical film is fixed to the first surface of the lens.
